(19) United States
(12) Patent Application Publication
(10) Pub. No.: US 2016/0086255 A1
(43) Pub. Date: Mar. 24, 2016

(54) System and Method for Maximizing Food Selection Options According to Shopper Preferences, Health Requirements, and Price Preferences and Ensuring Selected Food Freshness to Provide a Complete, Efficient, and Enjoyable Off-Site Grocery Shopping Experience that Benefits Both the Off-Site Shopper and the Grocery Retailer

(71) Applicants: Majnheiv Sainfort, Miramar, FL (US); Bjorn Ritschewald, Bremen (DE)

(72) Inventors: Majnheiv Sainfort, Miramar, FL (US); Bjorn Ritschewald, Bremen (DE)

(21) Appl. No.: 14/458,224

(22) Filed: Aug. 12, 2014

Related U.S. Application Data
(60) Provisional application No. 61/864,933, filed on Aug. 12, 2013.

(51) Int. Cl. G06Q 30/06; G06F 17/30; G06Q 10/08; G06Q 20/40

(52) U.S. Cl. CPC G06Q 30/0637; G06Q 30/0613; G06Q 20/405; G06F 17/3053; G06Q 10/087

(57) ABSTRACT

An integrated shopping and order fulfillment method and system is described whereby the customer is able to tailor her grocery shopping list according to her selected preferences from the product inventory offered by a retailer grocer and viewable on the user's mobile phone device. Once the order is placed, the system initiates its order fulfillment methodology whereby a unique barcode is generated for tracking all packages associated with the order. The items are sorted according to their assigned perishability ranking to generate a packing order list for use by the retailer grocer. The packing order list provides an optimized packing order schedule to ensure the freshness of all perishable items upon the order's pickup and delivery. Selected preferences may include red alert options to warn the consumer of an undesired level of a designated ingredient and black out options to eliminate the posting of a particular food type during shopping.

### TECHNICAL FIELD OF THE DISCLOSURE

The present invention relates to an on-line grocery order shopping system and method with a mobile connected device which integrates advanced search options for customizing the shopping experience and an order fulfillment system for ensuring the accuracy of the order and the freshness of ordered perishable food items.

### BACKGROUND OF THE INVENTION

In today's time-strapped society grocery shopping is often thought of as a time-wasting but necessary task. Indeed, many times both families and single individuals would rather purchase take-out food then spend time on the steps generally associated with the grocery shopping process. These steps generally include the following: 1) driving to the store; 2) searching for a parking space; 3) navigating store aisles searching for desired items; 4) loading the grocery cart with food items; 5) standing in line, e.g., at the deli or meat counter; 6) unloading the cart during checkout while often standing in line at the store's checkout counter waiting for empty counter space on which to place the cart's items to become available; 7) loading the groceries in the car; and 6) unloading and organizing the groceries once home.

The time involved for each separate task will of course depend upon the day and time that a grocery shopper heads for the store. The more crowded the store, the more time that may be required for finding a parking spot, waiting in line to check out, etc. Moreover, most working adults tend to shop during the busiest times and days of the week, thereby likely encountering long lines, crowded parking lots, etc.

For the time-strapped individual, the whole grocery shopping process can be tiring and stressful, especially after a long day at the office. It is not surprising that fast food restaurants have gained in popularity over the years and have often become a substitute for a healthy home-cooked meal because grocery shopping, of course, is a prerequisite for a home-cooked meal. If the shopper has run out of food at home, a fast food restaurant or even a more traditional restaurant offer a tempting alternative to avoid making a trip to the grocery store.

Grocery stores are therefore engaged in a very competitive business not only within the industry itself but also with the restaurant industry. Today the grocery store market is generally controlled by large regional chains. In addition, national discount stores also offer grocery departments in many of their locations, and these stores have further increased the competition in the grocery store market. The profit on an individual grocery item is generally slim and grocery stores therefore try to maximize their profits through reduced costs and/or increased shopper traffic. Yet, as discussed above, increasing shopper traffic can be a very challenging marketing endeavor because many people find the whole grocery shopping experience to be a stressful and time-consuming activity.

In addition, cost control is extremely important in this low profit margin business where strong and weak players may be decided by a nominal difference in net margins. Grocery stores often have a major challenge in effectively managing their perishability inventory where perishables constitute at least fifty percent (50.0%) of the total sales. Yet an average of six percent (6.0%) of perishable sales is lost due to a combination of price discounts to meet the sell-by-date and waste due to unsold, expired product, and the costs to dispose of the unsold perishable items. Such expired perishable items are generally not even usable by food kitchens for distribution to those who are in need.

The foregoing illustrates that grocery stores and grocery shoppers have a symbiotic but often tense relationship. The grocery store depends on shoppers for its very existence let alone being profitable in a highly competitive business. Certainly in our non-agrarian society, most people have no choice but to purchase their groceries at a grocery store, but often do so very begrudgingly due to their hectic schedules.

Moreover, the proliferation of fast food and other restaurants has resulted in a convenient “eating” alternative for many so that a trip to a grocery store is not necessary when the cupboard is bare. Yet, it is also an established fact that the increase in obesity and diabetes can be at least somewhat attributed to the frequent consumption of restaurant food, often substantially higher in calories and sugar and fat content than food prepared at home with items generally purchased at a grocery store, including specialty grocery stores.

Nor does a trip to the grocery shopping always result in healthy food choices. For example, many shoppers simply do not have the time to read food labels while shopping and may at times make questionable or even “unknowing” food choices because they are not aware of what exactly is in the food they have chosen. Many individuals would be surprised, for example, at the salt content of canned soups or that sugar is often present in many foods other than sweets.

Moreover, many individuals have food allergies wherein traces of peanuts, for example, may cause a severe allergic reaction. Failure to scrutinize food labels for information on the food content or the nature of the manufacturing facility (e.g., one where nuts are processed) may result in a serious health problem when the food is consumed. Yet even the most discriminating and careful food shoppers may well find food labels challenging to read because of their small size and thereby miss important information. In addition, shoppers can be tempted to make “bad” food choices when faced with aisles, rows, and tables of tempting foods, especially sweets and snack foods.

The prior art recognizes that grocery shopping can be a trying experience for time-strapped shoppers. The proliferation of computer and smart phone technologies has resulted in prior art attempting to resolve the efficiency-related problems. For example, Sussman (U.S. Pat. No. 7,599,855) teaches a system for and method for a complete and convenient shopping experience that allows the consumer to generate a grocery list at home using a UPC code scanner to scan a grocery item that has either run out or needs to be restocked shortly. The consumer uses the UPC barcode scanner to record the barcodes of items to be added to the grocery list. She can have the scanned UPC codes uploaded to an at-home base station (a personal computer or a cell phone) having a local UPC barcode database. She can then obtain a printed grocery list from a printer connected to the base station or she can send her shopping list to a store that provides a method to receive consumer's pre-generated grocery list electronically. In the latter embodiment, the store makes the products listed on the transmitted grocery list available for purchase by the consumer, thereby eliminating the need for the consumer to shop in-store for the transmitted grocery list items. She can also simply take the barcode scanner to the store and use it as a grocery list since the scanner displays the item(s) to be purchased based on her input. Sussman's patent basically provides an automated grocery shopping list driven by UPC barcodes. It does not provide an off-site shopping method wherein the shopper can make alternative food choices just as if she were in the store itself.

Moreover, although it includes various embodiments that reduce the time associated with preparing a grocery list and shopping, Sussman's invention does not address the efficiency of the shopping process from the store's end. For example, Sussman's invention provides for filling of the orders by a store, but does not address the situation where the consumer's grocery list includes perishable items. Some level of coordination is required between the grocery store and the consumer to ensure that ordered perishable goods do not thaw and/or remain at room temperature for extended periods while awaiting pickup. Sussman's invention does not provide for such coordination. In addition, Sussman's invention does not provide a method for the consumer to ensure that that the order has been correctly filled or properly stored prior to pickup or delivery.

U.S. Pat. No. 7,801,774, issued to AT&T Intellectual Property, L.P. as the assignee, teaches an integrated system wherein the consumer transmits her grocery list to a store's Grocery Management System (GMS) that allows for the updating of the consumer's grocery list with suggestions, advertisements, coupons, and/or store promotions. The GMS can be programmed to identify the location of each item on the transmitted grocery list and the list can be fine-tuned to reflect the preferred shopping order such that frozen foods are placed at the end of the list. The actual grocery shopping step as envisioned by the '774 patent is conducted by a store employee with a UPC barcode scanner in hand. Once the user/agent has completed shopping as per the updated grocery list, if any, the UPC barcode scanner is presented to a purchase fulfillment system so that payment can be made.

The '774 patent contemplates the situation where the shopping order is filled and actually delivered to the consumer all in the same day. This does not necessarily mean that the order is not placed in advance, but once shopping is commenced, it is completed and delivered just as if the shopper had gone to the store, shopped, and gone home with the purchased groceries.

Although the '774 patent provides an integrated system for off-site grocery order fulfillment, the invention is not practical from either the shopper's or the grocery store's perspective for situations where the shopper or an agent for the shopper will be picking up the groceries on a later date. For example, a grocery shopping method based on delayed pickup must consider the maintenance of the integrity and nutritional value of any ordered perishable and/or frozen foods until the order is actually picked up. An off-site shopper should have confidence that the perishable and/or frozen foods were stored properly prior to pick up. At the same time, the store that is willing to provide this convenient service should have flexibility in handling the filling of the order according to the types of ordered items and its storage capability.

U.S. Pat. No. 7,716,088, issued to Amazon as the assignee, is for a Method and System for Electronic Commerce Using Multiple Roles Shopping Cart. The '088 patent involves a system for keeping track of purchases made by the same purchaser where the purchaser needs to keep track of the purpose for the expenditures. For example, the system allows the purchase to place items to be purchased into a shopping cart identified as the purchaser's personal use shopping cart or in a shopping cart identified as the person's business-use shopping cart. The system is not specific for grocery shopping and pertains to all items available at www.Amazon.com. The '088 patent is distinguishable from the present invention because it provides a method for promoting efficiency in the segregation of the purchaser's expenses and purchases. It is not directed towards the actual grocery shopping process either from a shopper's or grocery store's perspective.

U.S. Pat. No. 6,536,189 issued to Thermal Products, Inc. as the assignee, is for a Computerized, Monitored, Temperature Affected Delivery System for Perishable Goods. The patent involves components for actually packaging perishable goods and maintaining the temperature of the packaged goods. The invention includes a time/temperature monitoring alert indicating when either a maximum predetermined temperature or a maximum allowed, elapsed time from packing to opening has been exceeded, after which time the perishable items are no longer warranted to be safe. The invention further involves an automated tracking system in which the customer is obligated to transmit a unique code to the purveyor when the package is opened. The '189 patent is focused on providing actual packaging materials for perishable goods and not on the shopping and actual packaging processes themselves.

None of the foregoing prior art provides the features of the present invention which provides an integrated method and system for combining a novel software driven online mobile grocery selection process with a novel software and barcode driven grocery store order fulfillment system wherein both the shopper and grocery store can realize specific benefits. The present invention, as a hybrid of inventive features benefiting both the shopper and grocery store, is a fully integrated approach to providing a total off-site grocery shopping expedition that provides for a level of innovation, sophistication and flexibility not present in the prior art.

### SUMMARY OF THE INVENTION

The present invention is directed to addressing the tension between grocery store shoppers (stress, limited time) and grocery stores (strong competition for a limited pool of grocery store shoppers and competition with fast food restaurants for the consumer's hard-earned dollars) by improving the efficiency, convenience, and enjoyment of the overall the grocery shopping experience. The invention's utilities benefit both the shopper and the grocery store. As it relates to the shopper, the invention transforms the typical shopper into a shopper who can proactively control his or her food selection through inputs to eliminate potentially dangerous foods (e.g., foods with a known allergen) to unhealthy foods that are often the result of impulse buying and/or temptation resulting from viewing tasty food choices on prior art websites which are too often unhealthy (e.g., processed snack foods). In addition, the present invention comprises methods for: 1) informing the off-site shopper as to available food items including food items many shoppers may not even be aware of such as beef from animals raised on humane certified farms and foods consisting of non-genetically modified ingredients; and 2) allowing the off-site shopper to make choices according to her own preferences at a level not provided in the prior art.

As it relates to both the shopper and grocer, the invention provides a method for initiating and organizing the food order packing process according to a unique perishability ranking system and the designated date of delivery or pick-up via an innovative barcode. In this way, the invention helps assure the shopper that the perishable items ultimately selected by the grocery store employees are truly fresh and not past the “sell by” or “use-by date at the time of pickup or delivery. The invention further allows shoppers to place their order a week or more in advance with confidence that the order will be stored, packaged, and filled properly to ensure optimal freshness and nutritional value of perishable foods.

As it relates to the grocery store, the perishability ranking system improves cost management processes by reducing the costs associated with the disposal of expired perishable foods through improved inventory control of its perishable items. That is, the unique bar code with its embedded perishability ranking adds another level of inventory control and will allow the grocery store to readily monitor off-site grocery purchases relative to on-site grocery purchases.

The unique barcode is also used by the grocery store in tracking and organizing the various packages associated with a particular order to ensure that all packages will be delivered to the shopper or “handed over” to the shopper or the shopper's agent upon pickup directly from the grocery store. Such a feature is important where the packages may be stored in different sections of the store until pickup and allows for the efficient handling of large orders including foods covering several perishability rankings.

To fully appreciate the benefits of the invention's own unique barcode, some background on Universal Product Codes (UPC codes) is in order since they are mentioned in the prior art and today are a ubiquitous part of the in-store shopping process for virtually all goods-providing stores. Also, the above referenced prior art utilizes UPC codes to meet the objectives of the respective patented inventions.

Today, grocery items (and most if not all retail items) typically include a UPC code for the associated product on either the package or the product itself. This system speeds up the checkout process at grocery stores and helps the store keep track of inventory. The UPC code consists of a combination of 12 numbers and vertical black-colored bars of various widths and separated by spaces of various widths. The first six digits identify the manufacturer code. The next five digits give the item number and the last digit serves as a check digit. At checkout, a barcode reader scans the UPC with an opto-electric device, transforms the optical image into ASCII binary code, and sends the UPC code to the store's point of sale computer. The whole process takes place in less than a second. The UPC codes play no role in influencing grocery shoppers' buying decisions one way or another. They are used only to track inventory and price store items at checkout. By the time the shopper has reached the checkout counter, the food choices have already been made.

The invention's unique bar code, on the other hand, provides a cross check on the order's total and also provides for multiple package tracking where the order is associated with more than one package. As a result, the present method provides the grocery store with an innovative automated system that will allow participating grocery stores to ensure the accurate filling of even very large off-site orders with a variety of perishability food types in a cost efficient manner.

The present invention contemplates the situation wherein the consumer or his/her agent will often choose to pick up the groceries and is relying on the grocery store to have the order correctly filled by a specified pickup date and time. This feature provides the shopper with a way to coordinate grocery pickup with his/her schedule and provides flexibility in today's harried world particularly wherein the grocery store is part of a chain of grocery stores utilizing the invention. By way of example, families who are traveling to a vacation destination where they will be doing most of the cooking may wish to simply place an order with the grocery chain's local store in advance of their arrival. That way, they will not have to waste time on grocery shopping upon arrival, but can simply retrieve their filled order. Also, a working parent who will be within a short distance from a selected grocery store on a Thursday due to a child's dental appointment can use the method to arrange for pickup of the items on her grocery list after the dental appointment, thereby saving on gas and shopping time. The off-site grocery order's associated packages, packaged according to the invention's novel features, may, however, also be delivered to the off-site shopper by an employee of the grocery store itself or a third party delivery service.

### BRIEF DESCRIPTION OF THE DRAWINGS

FIG. 1. Schematic showing the relationship of the invention's hardware and software components.

FIG. 2. Schematic of the Top Level Overview of the Invention's Off-Site Shopping Expedition (OSSE) System.

FIG. 3. Schematic of the Top Level Shopping Options for the OSSE System Customer by Food Type and Example Of Shopping Procedure.

FIG. 4. Schematic of the Item Selection Record Prior to Perishability Ranking by the OSSE System.

FIG. 5. Schematic Showing Item Sorting According to Perishability and Storage Requirements and Associated Order-Specific Barcode Label Data.

FIG. 6. Schematic of the Invention Packaging Procedure According To Perishability Ranking If to Be Packed on Different Days and Not All at Once.

FIG. 7. Schematic Providing Examples of Additional Shopping Options for the OSSE System Customer by Specified Food Characteristic.

FIG. 8. Schematic Providing Example of Red Alert Options.

FIG. 9A. Schematic Showing Example of the Invention's Shopping Options by Designated Cuisine.

FIG. 9B Schematic of “Blackout” Option Where the Shopper has Selected to Eliminate Access to Bakery Goods Listings.

FIG. 10. Schematic of the Invention's Organic Food Selection Option.

FIG. 11. Example of Categorization of Food Purchases According to Percentage of Total Bill Spent on Top Level Food Items.

### DETAILED DESCRIPTION OF THE INVENTION

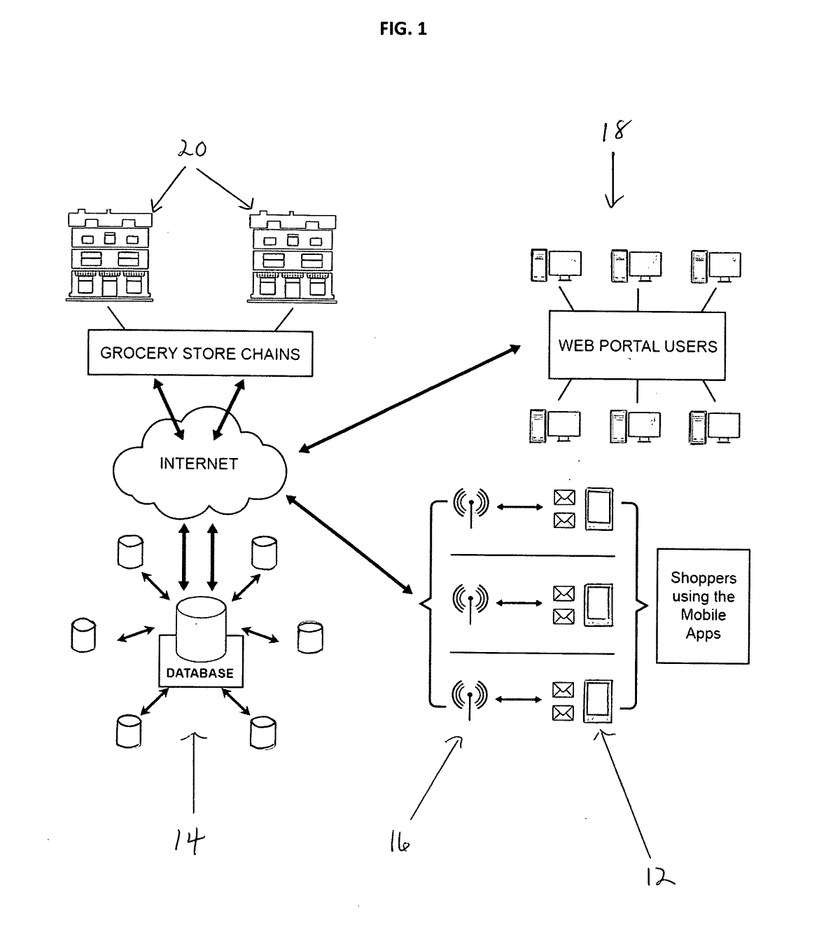

The invention provides a fully integrated system for expanding the shopping preferences for off-site shoppers and improving both grocery inventory management technology and packaging technology. To achieve these benefits, the invention is comprised of hardware elements, software elements, wireless communication elements, and barcode elements. Referring to FIG. 1, a combination 10 of hardware elements comprises the devices utilized by the shopper and grocery store respectively to practice the inventive method. The hardware devices are: 1) one or more servers 14 for running the invention's web application and storing and maintaining system's required data bases using a centralized architecture wherein the server(s) may be located within a specific store location(s) or at a co-located data center(s) either operated by the participating store chain or by a third party; 2) communication satellites 16 for receiving and transmitting information to and between the shopper and grocery store; 3) the participating grocery store's dedicated on-site computer(s) 20 for practicing the invention such as a desktop, laptop, or tablet computer; 4) bar code scanners or readers connected to the grocery store's computer for reading the inventive barcode sequence (not shown); and 5) the shopper's mobile or smartphone and/or other wireless electronic communication device 12 for accessing the invention's web application. In one embodiment of the invention, the hardware elements also include the grocery store's refrigeration and frozen storage units which have been configured to track the addition of and removal of packages associated with a particular order number when the items are ready for pickup by or delivery to the off-site shopper by the invention's unique barcode sequence (not shown).

The invention is executable by an OSSE grocer on a computer including a manually operated keyboard and mouse and running any Windows 7/8.x or Apple desktop/laptop/tablet using a modern browser such as Internet Explore 9+, Chrome, Firefox, or Safari. The dedicated computer server has a configuration comprising a CPU, O/S, a control panel, a billing panel, and a database. OSSE shoppers use the application by downloading it onto a smart phone such as an iPhone 4/5 or an Android phone 4+. The invention, may, however, also be practiced on a laptop or any smartphone brand or model capable of functioning with the invention's software.

The OSSE System has 4 key software components: the OSSE Administration Application, the OSSE Grocer Application, the OSSE Shopper Application and the OSSE Web Portal. The OSSE Grocer Application becomes available to a grocer for use once the OSSE administrator creates an account for the grocer via a browser interface. In a preferred embodiment, the grocer is a grocery store chain. The OSSE Administration Application provides a grocer administrative account via a browser interface to the grocery chain. The OSSE's grocery store chain users are of three types: the grocery store chain administrator who handles the administrative account for the entire chain; the manager of a store within the grocery store chain who handles the account for the local store, and store employees of the store with a limited access to various features of the OSSE Grocer Application as decided by the store manager. The grocery chain administrator has the flexibility to determine if all or only certain of its stores will actually participate in the OSSE program.

Where a grocery chain is an OSSE participant, the OSSE grocery shopper can readily enjoy the OSSE's benefits at different grocery stores within the chain. As an example, if the OSSE shopper typically shops at grocery store A that is part of chain X, but then moves to a location where it would be more convenient to pick up groceries at grocery store B that is part of chain X, the shopper will be able to practice the invention at store B, providing store B offers the OSSE method of grocery shopping. In this way, the OSSE provides the shopper with the ability to enjoy the OSSE's benefits at different locations of stores within a store chain that utilize the OSSE method of off-site grocery shopping without having to “start over” with another OSSE grocer.

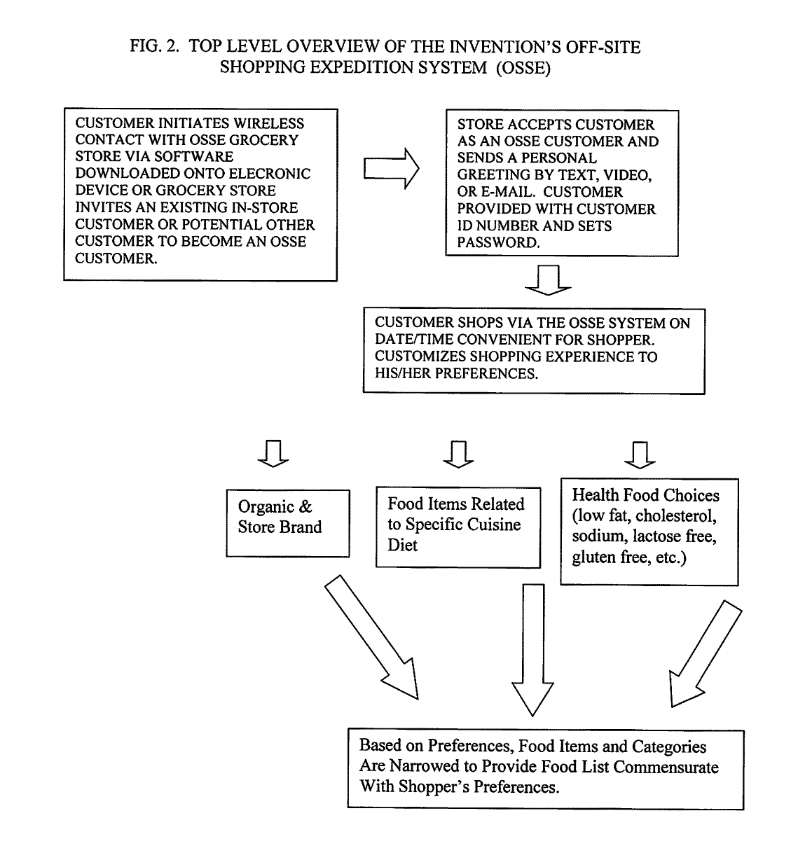

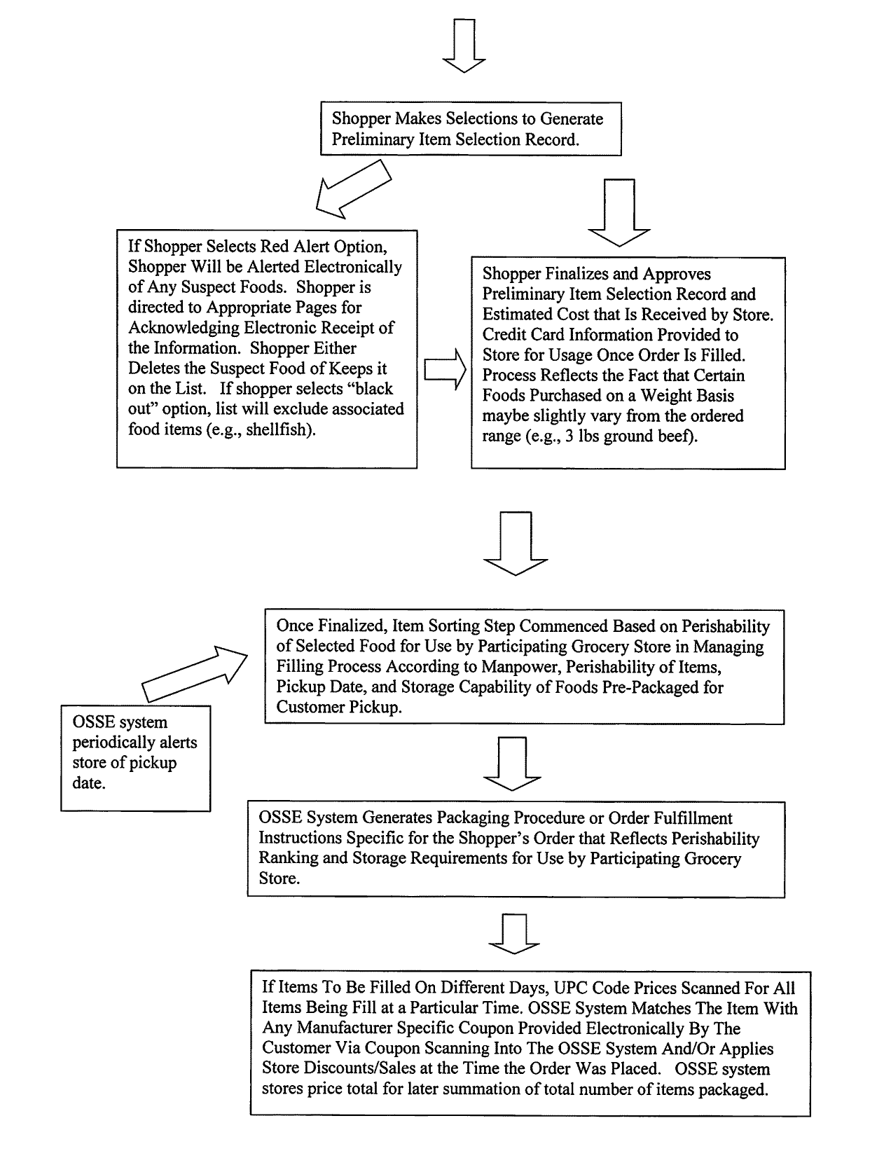

Referring to FIG. 2, the OSSE grocer invites existing or prospective customers to download and activate the OSSE Shopper Application. The invention's interactive software also allows the OSSE grocer through the store manager to personally welcome the potential shopper to the off-site grocery shopping experience via an e-mail message, text message, or welcome video by the store's manager. In this way, the potential OSSE system shopper will not feel that he/she will just be a number as an off-site shopper, but is actually a valuable store customer even though she is not actually present at the store. Indeed, one of the important objectives of the invention is to promote the enjoyment of the off-site grocery shopping experience by providing the grocery store with a communication means of showing customer appreciation remotely.

Referring to FIG. 2, the invention's integrated shopping and packaging system is initiated when the shopper accesses the invention's interactive software. The software may be downloaded directly onto the shopper's wireless communication device or the shopper may access the interactive software through the World Wide Web. The off-site shopper new to the OSSE first determines if a particular grocery store according to name and zip code is an OSSE grocery store participant. This may be done by inputting the name of the desired store, or the shopper's preferred store location according to zip code, or both the zip code and store name. This feature allows the OSSE shopper to determine if her favorite store is an OSSE participant or locate other OSSE participating stores. If the search yields an OSSE participating store she wishes to shop at via the OSSE, she must first be accepted by the OSSE participating store as an approved OSSE off-site shopper and receive a customer identification number. Once accepted and completing an order, she will be designated as an OSSE shopper.

If the OSSE participating store is part of a chain, her customer identification number will allow her to shop at another chain owned by a participating OSSE store chain at any location without having to be accepted again as an OSSE customer. An OSSE participating grocery store chain, however, has the option of including only certain of its stores as OSSE participants or all of the stores within the grocery chain. The OSSE participating store chain also has the option to add additional stores as OSSE participating stores at any time.

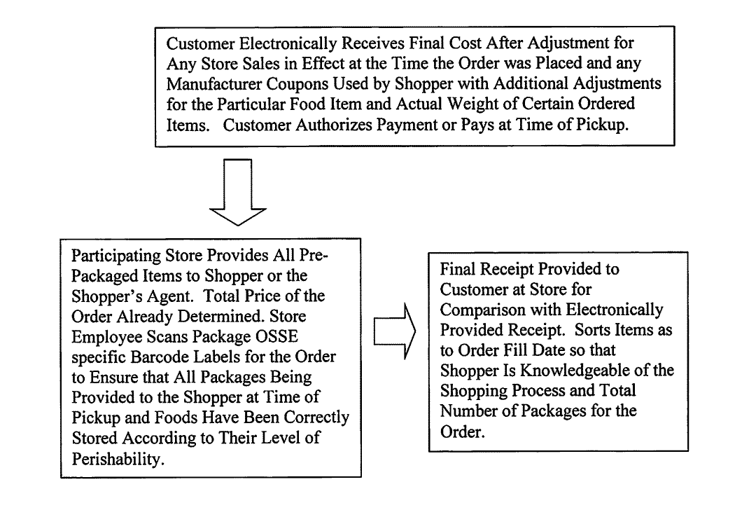

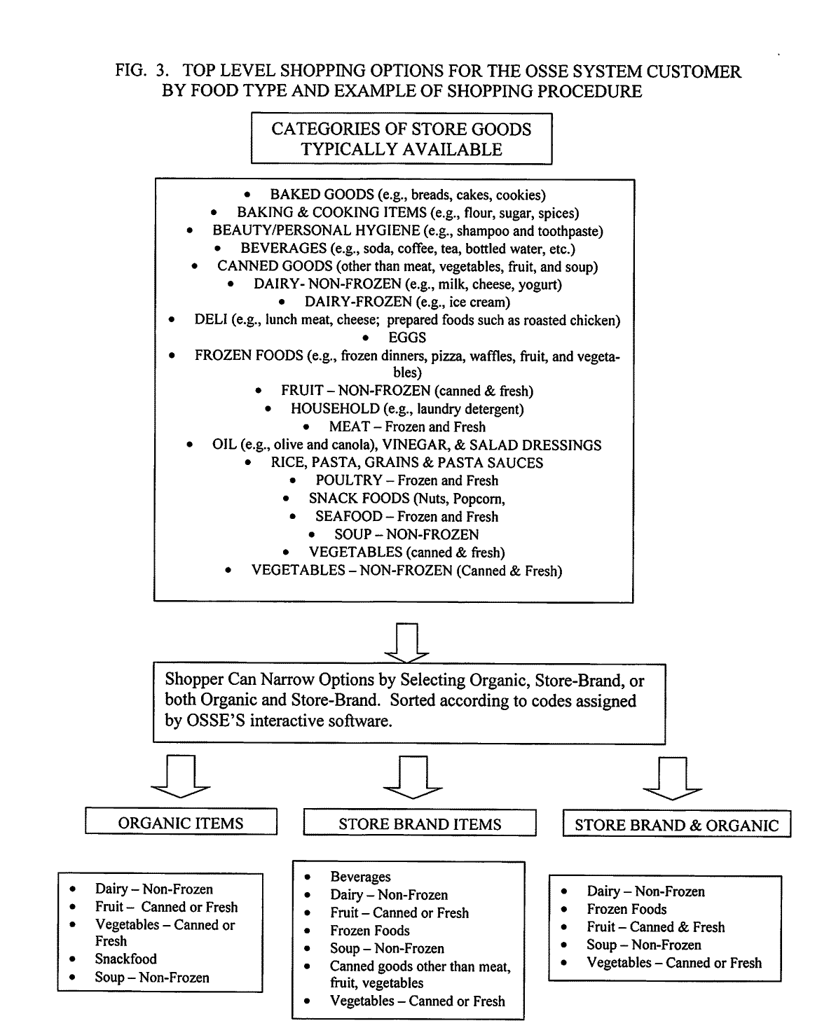

Once the interactive software becomes accessible to the OSSE shopper, the OSSE shopper will have access to the selected OSSE grocer's inventory list made available by the selected OSSE grocer to OSSE shoppers. Referring to FIG. 3, the shopper makes selections through the top level categories offered by the grocery store through the OSSE's interactive software. The OSSE participating store determines what products within its inventory it will offer for purchase through the OSSE's interactive software. OSSE grocers may choose to limit the food items they offer for sale to the off-site customer through the interactive website or they may make their entire selection of items available. The OSSE grocer may alter its offerings at any time. It is anticipated that OSSE participating stores will expand their offerings to include more choices and options upon the system's successful implementation as defined by customer satisfaction, an expanding OSSE shopper customer base, and new store customers who value the OSSE experience and who had not been frequent in-store shoppers at the OSSE participating store.

This flexibility on the part of the OSSE grocer to alter its inventory recognizes that filling off-site orders may take one or more additional, dedicated employees. At least until the grocer has reached its critical mass of OSSE off-site shoppers, limiting the available inventory to anticipated “most likely items to be purchased” allows the grocer to manage any associated costs of providing this service. The participating OSSE grocery store may also require payment of a service charge or require the placement of a minimum specified order.

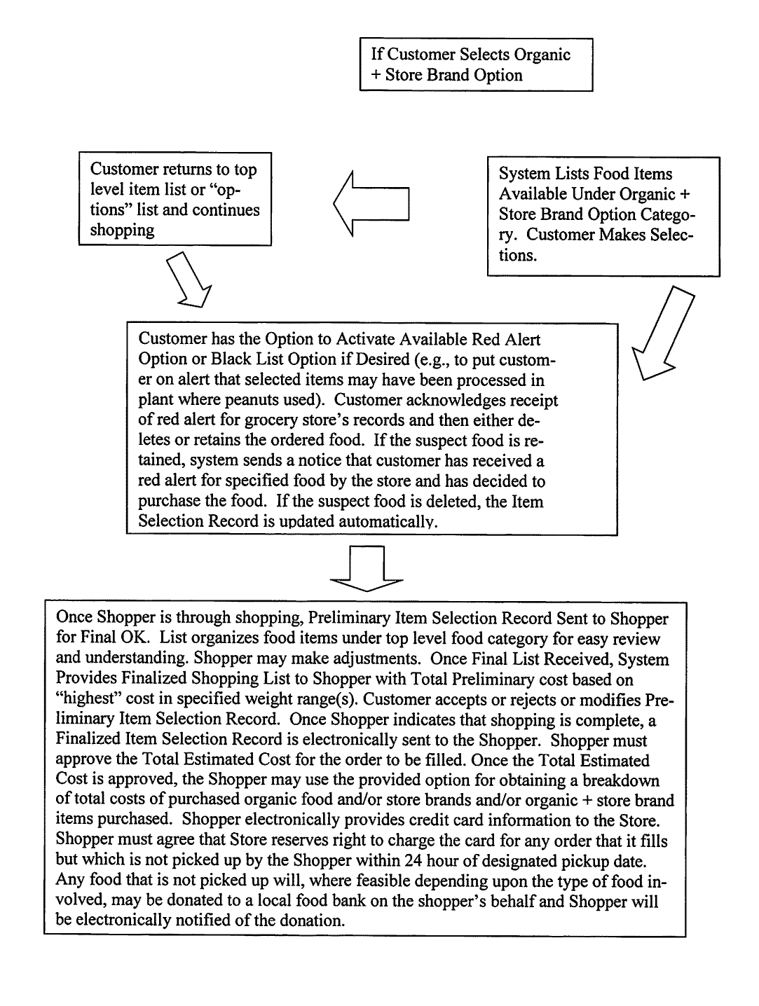

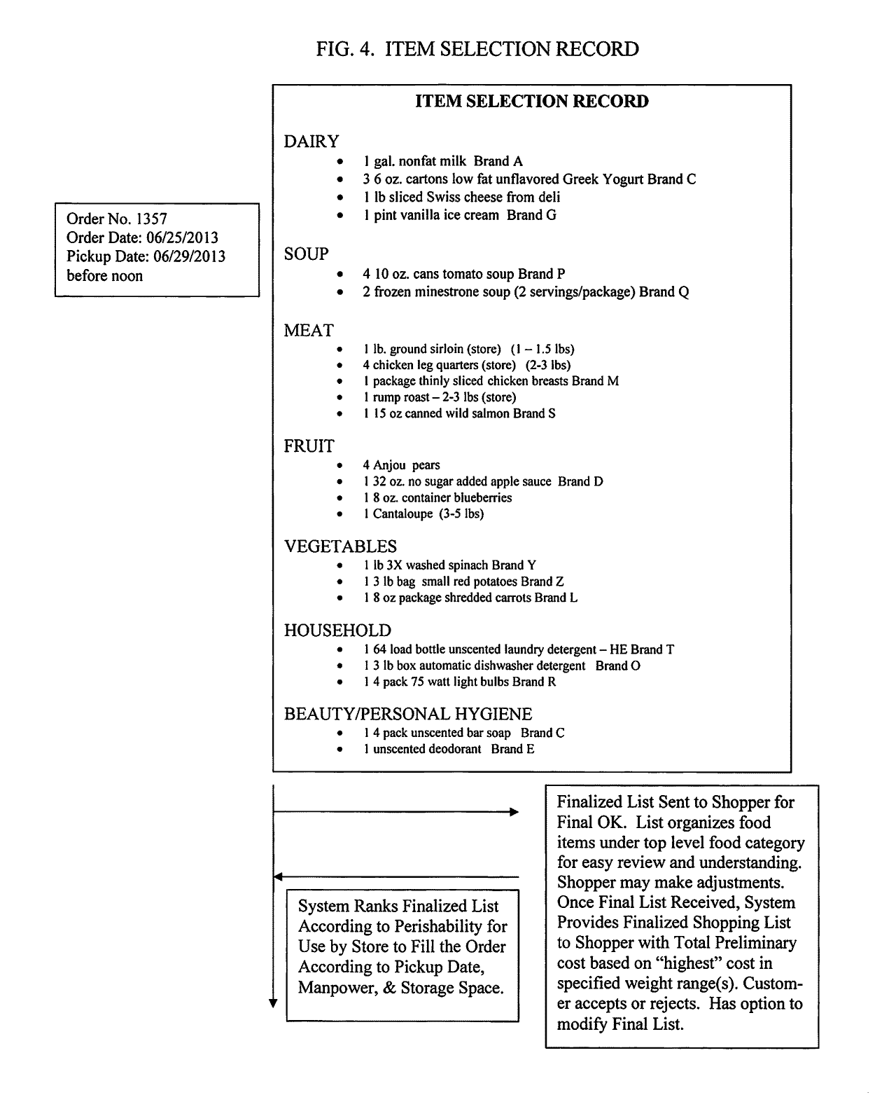

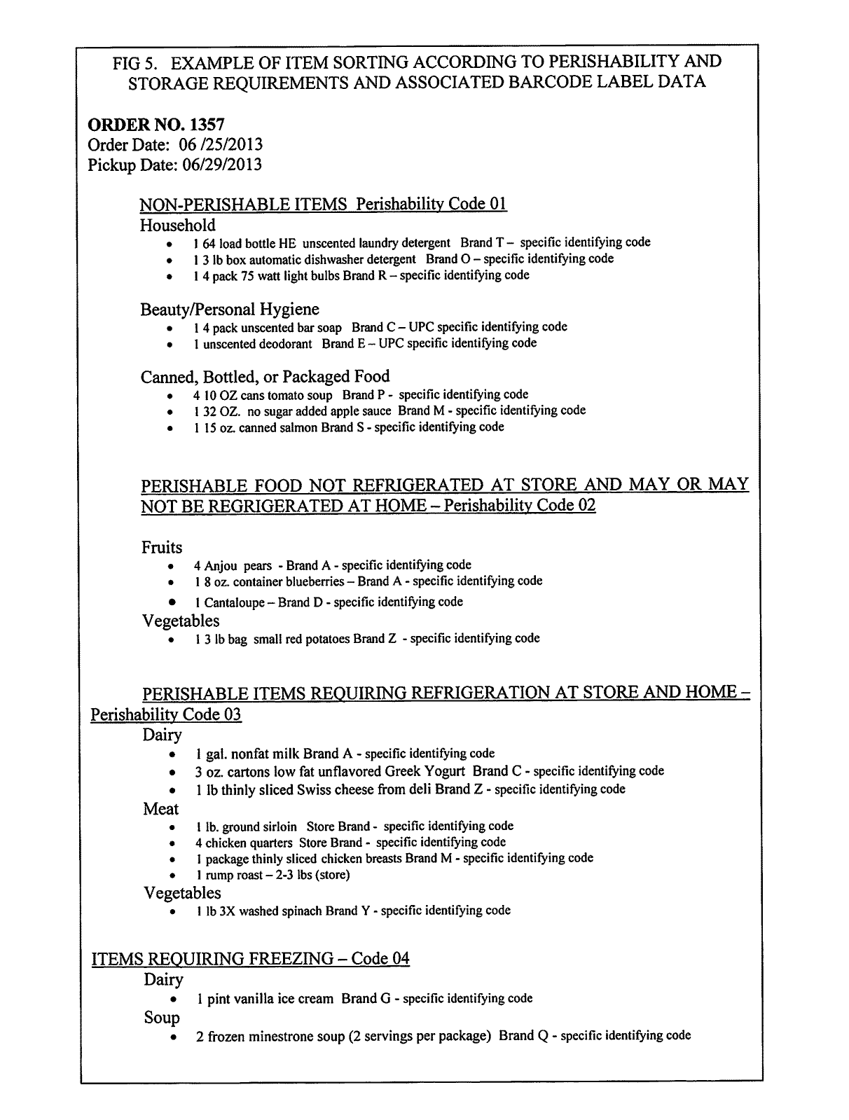

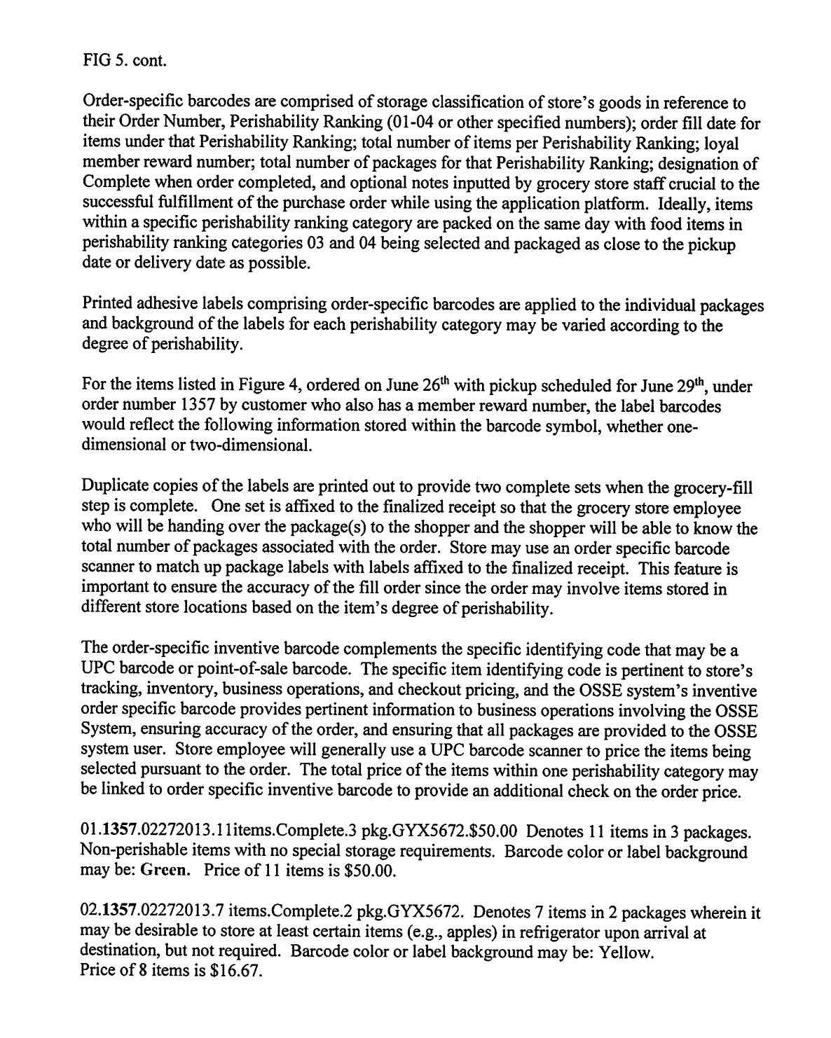

Referring to FIGS. 3 and 4, the OSSE store participant's top level categories are further divided into subcategories, classes, and subclasses. Thus the top level dairy category may be further divided into numerous subcategories (e.g., milk, yogurt, and cheese). Each subcategory may then be further divided into classes (e.g., Greek yogurt) and subclasses (e.g., no fat). Once the item is selected, the shopper then is taken to a menu with the brand names under which the selected item is sold (e.g., FAGE®, DANNON®, or STONY FARM®). This example establishes how the inventive software is used to narrow the selection process in particular for undecided shoppers, i.e., those shoppers who do not necessarily always pick the same brand of any particular food item. In this way, the OSSE system provides the off-site shopper with the opportunity of selecting alternative brands and selecting alternative products to provide a truly flexible shopping process. In contrast to the '885 patent, the shopper is not dependent upon product specific UPC barcodes to generate the shopping list.

In addition to scrolling through the various subcategories, etc., at any time within a subcategory, the OSSE system user has the option of simply inputting the preferred brand, size info, and quantity.

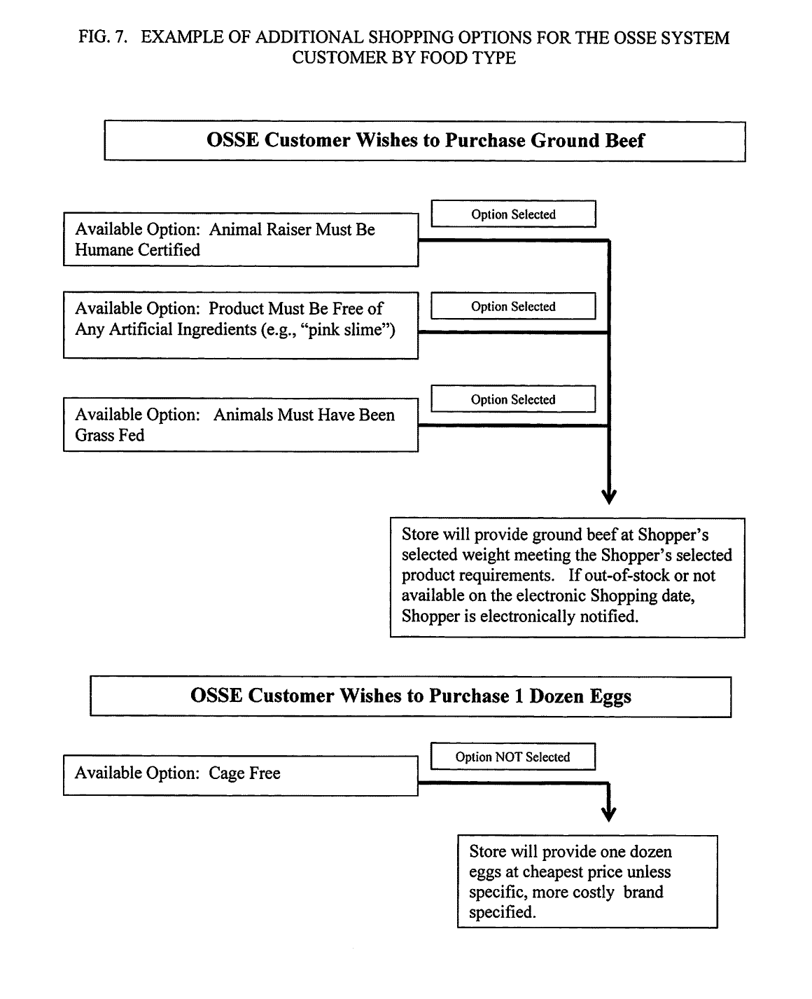

Referring gain to FIG. 3, the OSSE shopper can customize or narrow her options by selecting various tier options offered by the participating grocery store such as organic, vegetarian, or store brand options. To further narrow her choices, the shopper may select more than one Tier to operate simultaneously with another Tier. By way of example, the selection of the Tier for organic foods and a Tier for store brands would narrow the shopper's choices to organic store brands. The Tier options allow the shopper to quickly hone in on desired food preferences. Referring to FIG. 7, the flexibility of the inventive Tier option feature is further illustrated by possible Tier options pertinent to ground beef. For example, the OSSE grocer may wish to offer Tier options related to animal products from animals certified to have been treated humanely (e.g., allowed to roam freely in pastures) or fed a certain diet.

Another Tier option may be specific for price, i.e., a Tier option for providing the cheapest item of any particular category or subcategory. The OSSE's Tier options are many and provide a sophisticated means of educating OSSE shoppers to a wide variety of foods and food choices for those shoppers who are not particularly price conscious. The OSSE's flexibility does, however, also provide for Tier options benefiting the price conscious OSSE shopper.

Referring again to FIG. 3, both the OSSE shopper and OSSE may find the store-brand Tier to be particularly attractive. Store brands are generally cheaper than most other brands and generally have the same quality as the more expensive brands. Nevertheless, even in-store shoppers are often not even aware of all of the available store brands. The OSSE system allows the grocery store to have its own brands featured via a store-brand-only Tier option and in this way provides an unexpected benefit of putting store brands on an equal footing with other brands.

Tier options may also be used for household items the OSSE grocer may offer for purchase. Thus shoppers who are interested in purchasing environmentally friendly “green” cleaning products may be very interested in using a Tier option specific for such products. Indeed, the Tier system may well serve as a way to quickly educate OSSE shoppers as to food and household items they were not previously familiar with or had time to learn about during in-store shopping.

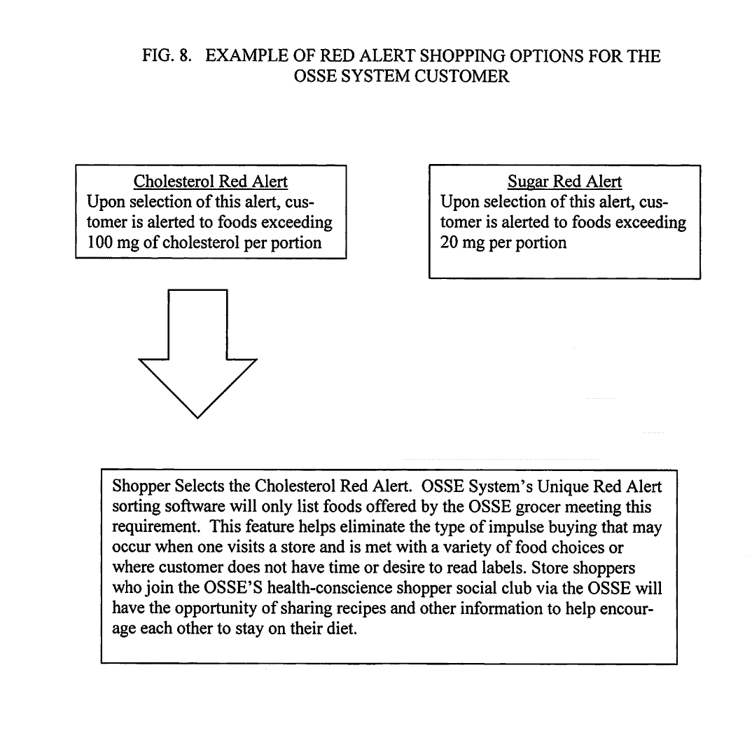

Referring to FIG. 8, in an embodiment of the invention, the shopper may additionally narrow her choices by utilizing the OSSE's inventive Red Alert options to alert her to any undesirable food characteristics. The inventive Red Alert option applies to those foods which the shopper may still have an interest in buying, such as a high caloric food, but nevertheless still wishes to be informed of a particular food characteristic the shopper considers important enough to be alerted about. In the high caloric food example, the associated Red Alert warning would appear on the mobile phone user's screen for a selected food exceeding, for example, 600 calories per portion. As another example, other available Red Alert options may be for processed meat products which contain sodium nitrite and foods wherein the sugar content exceeds 20 mg per serving.

Another Red Alert option may be for cholesterol levels exceeding 100 mg. By activating this particular Red Alert, the OSSE shopper will be alerted to any selected item with a cholesterol level exceeding, for example, 100 mg per serving. Regarding any “Red Alert” item appearing on her mobile phone screen upon selection of a specific Red Alert option, the shopper will have three (3) options: 1) stay with the original selection and continue shopping; 2) delete the original selection and continue shopping; or 3) request suggested substitutes of the same food category having the required cholesterol level per serving.

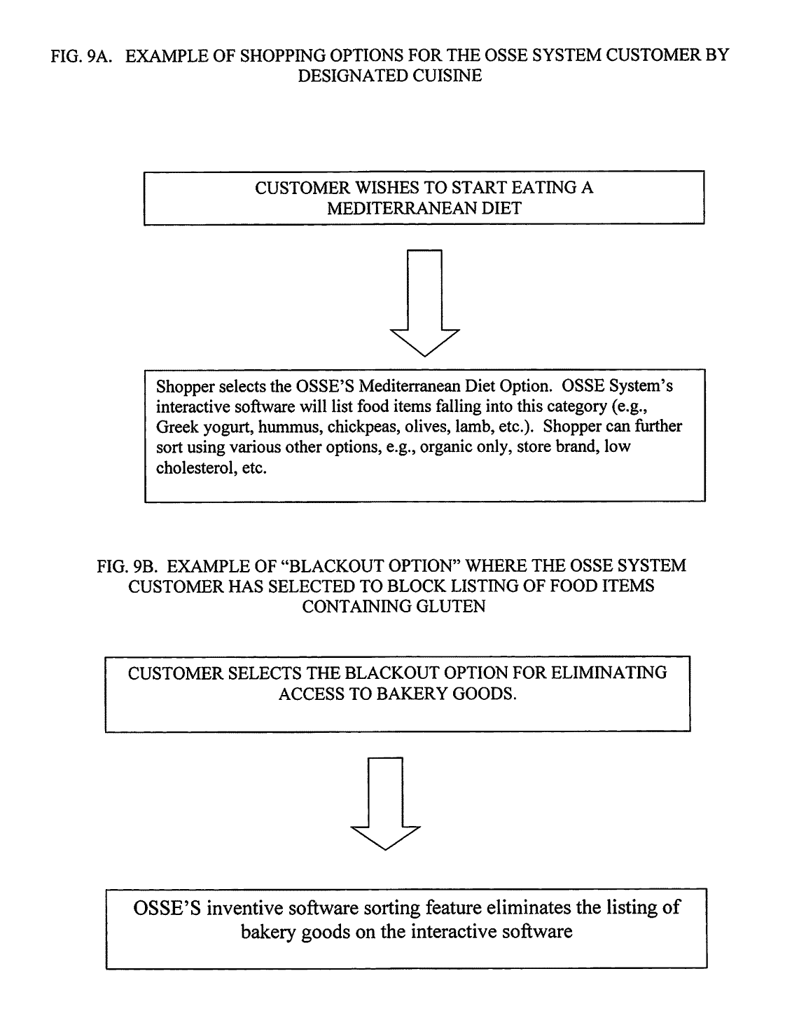

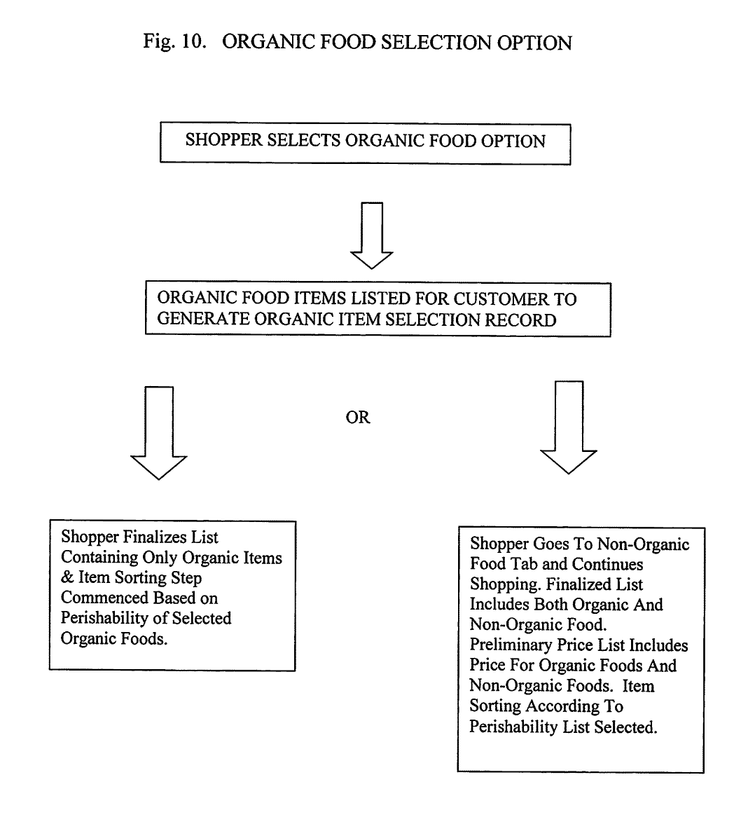

Referring to FIG. 9B, in another embodiment of the invention, the shopper may also select one or more Black Out options to further narrow her food choices. The inventive Black Out option applies to those foods which the shopper does not wish to purchase at all or does not even want to be tempted to purchase. As with the Red Alert option, the grocery store may offer one or a plurality of Black Out options. Moreover, the OSSE methodology provides the participating grocery store with the means for assigning the foods it plans to offer for purchase through the OSSE system to the appropriate Black Out category.

The Black Out option serves two purposes. First, it eliminates foods that may pose a real danger to the purchaser or the purchaser's family member, such as food containing peanuts from being made available for purchase. Second, it eliminates any temptation associated with selecting unhealthy foods the shopper is truly intent on avoiding such as high caloric soft drinks or bakery goods.

One or a plurality of tiers, Red Alerts, and/or Black Out options, or any combination of the three, may be offered by the OSSE's participating grocery store, depending upon the participating store's marketing objectives related to maximizing the flexibility of the off-site grocer's food selection options. The OSSE food characteristic sorting methodology provides the participating grocery store with the means for assigning the foods it plans to offer for purchase through the OSSE interactive ordering system to the grocer's selected tier, Red Alert, and/or Black Out options and offers a plurality of available options to the grocery store.

Whether practiced individually or together, the Tier, Red Alert and Black Out inventive elements provide the shopper with the means of accessing the qualities or characteristics of selected food choices in the absence of having any access to package food labels as does an in-store shopper. These inventive features transform the off-site shopping procedure into one where the off-site shopper can readily and quickly make food choices based on her own selected requirements. In addition, the Tier, Red Alert and Black Out inventive elements provide a means of encouraging the shopper to make educated food choices or at least have the option to do so. In-store grocery store shoppers may not necessarily make educated choices or even read food labels. In contrast to the prior art, the present invention is not merely a method for allowing the placement of an off-site food order but an inventive system that actually informs and educates.

The OSSE shopper has the option of saving her selected Tier, Red Alert, and Black Out options for repeated use when she places another order through the OSSE system involving the same OSSE grocer. When the OSSE shopper is shopping through an OSSE store that is part of a grocery chain, her saved selected Tier, Red Alert and Black Out options will “carry over” to other OSSE participating chain stores. Indeed, one of the realizable advantages by the OSSE shopper is that successive shopping expeditions may well take less time than the very first shopping expedition based on her established buying preferences.

In recognition of the benefits of Tier, Red Alert and Black Out options to at least certain OSSE shoppers, the OSSE grocer may charge a fee for utilization of its Red Alerts and Black Out options. This pricing option recognizes that the OSSE grocer is providing a novel shopping service system that both saves time and allows the off-site shopper to be fully in charge of the shopping process.

Referring to FIGS. 2 and 4, an embodiment of the invention recognizes that certain items, particularly fresh meat and seafood, may present some level of difficulty in assigning a final fixed price until the item is actually packed by the OSSE grocery store employee. For example, if the OSSE shopper wanted a beef rump roast weighing about 3.0 lbs, a range of available weights may be listed, e.g., 2.0 to 3.0 lbs to reflect typical actual variation in this type of meat by the OSSE system. By selecting this meat item, the OSSE shopper must acknowledge her understanding of the shopping reality when it comes to selecting meat by granting the participating OSSE grocer permission to pack a roast up to 3.0 lbs and agree to pay the amount associated with the OSSE grocery employee's selection. As shown in FIG. 4, the finalized packaging list will contain the total price of the order according to the “maximum weight” approved by the shopper based on the cited weight range and the OSSE grocery employee's actual selection. In this way, the OSSE shopper is informed that there may be some variability in the store's ability to fill, e.g., a meat order, with a cut of meat of a precisely specified weight. Under this embodiment, the total price of the order may be either adjusted upwardly or downwardly, depending upon the cost associated with the selected item.

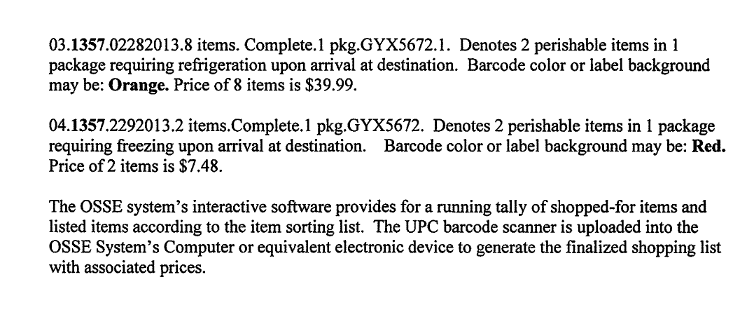

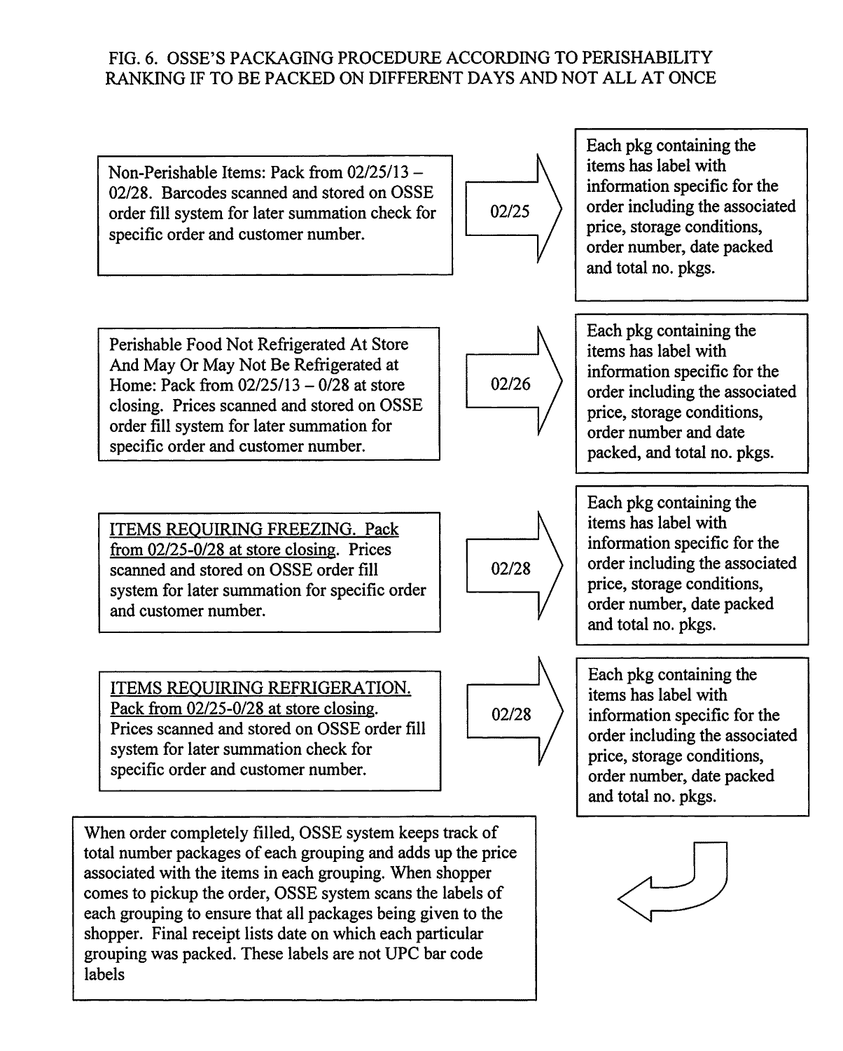

Turning now to the inventive packaging control method and referring to FIGS. 5 and 6, in the preferred embodiment of the invention, upon acknowledging receipt of the finalized order and receiving the associated payment from the OSSE shopper, the OSSE's methodology automatically sorts the selected food items according to the foods perishability rankings defined as follows:
Perishability Ranking 1—Non-Perishable Items.
   Examples: Canned, bottled, or packaged food; household goods such as laundry detergent; and beauty/personal hygiene goods.
Perishability Ranking 2—Perishable Food not Refrigerated at Store and Which May or May not be Refrigerated at Home and Generally Do Not Have an assigned Sell-By or Use-By Date.
   Examples: Fresh vegetables such as potatoes and carrots and fresh fruits such bananas.
Perishability Ranking 3 Perishable Items Requiring Refrigeration at Store and Home and Having an Assigned Sell-By or Use-By Date and Requiring Refrigeration at Home.
   Examples: Milk, meat, fresh sea food, certain fresh vegetables such as packaged spinach.
Perishability Ranking 4—Perishable Food Requiring Freezing
   Examples: Ice cream and pizza.

The invention's perishability ranking system overcomes the current limitations associated with off-site grocery shopping involving foods having a sell-by or use-by date. The off-site shopper who wishes to order such foods wants to be assured the foods to be picked up or delivered are fresh and not about to expire. The prior art associated with off-site shopping still causes the off-site shopper to be totally dependent upon the discretion of the employee responsible for filling the order. This fact may well discourage a grocery shopper from ordering a variety of foods, including perishable foods with sell-by or use-by dates, because the shopper does not fully trust the store employee to select the “freshest” foods or foods that are well within their sell-by or use-by dates. Such a concern may well arise when the off-site shopper is placing the order a few days in advance of pick up or delivery.

Referring again to FIGS. 5 and 6, the OSSE's inventive perishability ranking system overcomes this concern through a series of inventive packaging system steps. First, the OSSE system alerts the participating grocery store that foods have been ordered which have a sell-by or use-by date.

Second, to regulate the packaging process to ensure optimal freshness, and referring again to FIGS. 5 and 6, the OSSE's sorting methodology further sorts the items associated with Perishability Ranking 3 in order of decreasing shelf life. In contrast to the prior art, this inventive method recognizes that certain food types, such as fresh shell fish, have a very short shelf life before the item must to be consumed while other food types such as a fresh beef roast typically have a longer shelf life.

Referring again to FIG. 6, upon completion of the sorting step according to assigned perishability rankings, the OSSE's inventive methodology generates a detailed packaging schedule for use by grocery store personnel according to the ordered items' perishability rankings and the scheduled pick up or delivery date. Different items associated with Perishability Ranking 3 may be packaged on different days, depending upon the items' associated sell-by or use-by date and the date of scheduled pickup or delivery. Where the generated packing list includes foods associated with Perishability Rankings 3 and 4 and foods associated with Perishability Rankings 1 and/or 2, the grocer's employee can either fill the entire order on the same day on which the most perishable selected item (i.e., the item with the shortest shelf-life) is to be packed according to the OSSE system's generated packaging order list and instructions or the employee may complete the order at different times. In the latter case, ordered items associated with Perishability Rankings 1 and 2 may be filled ahead of the specified “package-by” date of the other items. The benefit of this feature from the grocer's point of view is that perishable or frozen foods can remain in their usual store locale, thereby reducing the number of additional refrigerated and/or frozen storage units that may otherwise be required for storing perishable and frozen foods for several days.

Another embodiment of the packing procedure includes an optimal packing scheme not only based on the food item's perishability but also according to the food's top level category. This inventive feature addresses on-site grocery store shoppers' complaints that groceries often are bagged at the checkout counter by store employees who do not pay attention to the types of food being placed into a bag especially when the store is really busy. By way of example, chicken that is packaged with other food items such as fresh produce may leak into the bag. Although perhaps rare, such intermingling of these food items may result in the transfer of bacteria from meat to produce.

The OSSE's inventive packaging scheme suggests the optimal manner for bagging food items to ensure freshness and safety. By way of example, the packaging scheme for an order including perishable chicken cutlets and perishable vegetables to be packed on the same day based on the specified delivery pick up date states that the meat and vegetables be packaged separately. Again, the inventive packing list and instructions help ensure that the ordered food items are handled to ensure freshness and safety.

In a preferred embodiment of the invention, to help ensure that the store completes filling the order before the scheduled pickup, the OSSE Grocer Application detailed below includes a signal transmission system for alerting the grocer as to the time remaining for filling and/or completing the order with perishable/frozen foods before the order is scheduled for pick up or delivery.

The invention's Perishability Ranking system ensures that perishable food with relatively short shelf lives, particularly fresh meats and dairy products, are retrieved as closely as reasonably possible to the shopper's pick up date by the store employee. The method includes a feature for monitoring the sell-by date for the pre-ordered perishable food item. The system alerts the store employee who is filling the order if the “sell-by date” item will have expired by the date the order is scheduled for pick up or delivery when the store employee inputs the sell-by or use-by date into the participating grocer's computer. This feature helps reduce situations where the freshness/nutritional value of a pre-ordered perishable food is no longer at the peak freshness/nutritional value stage and is nearing the “sell-by” date or has already reached that date. The OSSE provides for the possibility of customized off-site grocery orders, including items from Perishability Rankings 3 and 4, through a combination of efficient packaging management by the OSSE's participating grocer and the various food selection options available to the OSSE's participating off-site shopper. An unexpected result for the off-site shopper is the delivery of fresh perishable food items prior to the item's expiration date. An unexpected result for the grocer is tighter inventory control as it relates to tracking perishable food inventory to minimize waste.

The OSSE's inventive focus on packaging recognizes that shelf life information prior to packing the order by grocery store personnel is essential particularly where the order is to be picked up or delivered several days after the order was placed. An order for fresh shrimp which is packed one week before a scheduled pickup or delivery date simply will not be fresh or perhaps not even safe to eat. The result will be a disgruntled grocery store customer who will not view the off-site grocery ordering method as a reliable means of ordering perishable food.

Turning now to the barcode element, and referring to FIG. 5, in a preferred embodiment of the invention, the assigned Perishability Ranking is embedded in a unique barcode generated for each order received by the OSSE participating grocer wherein the barcode includes a specified Perishability Ranking. The unique barcode is separate and distinct from the ubiquitous UPC barcodes discussed above and serves a different purpose. The invention's initial package barcode only includes the order number, customer identification number, order pick up date, and Perishability Ranking according to the sorted grocery list and is initially used by the grocer's employee to identify a package as being associated with a particular order number and Perishability Ranking. The basic barcode is printed onto a label affixed to the corresponding package (e.g., a package containing Perishability Ranking 3 items).

Once the packaging process commences, the grocer's employee inputs information to the OSSE computer containing the OSSE Grocer Administration software on the number of packages associated with a particular Perishability Ranking, the package fill date, storage unit location and any notes or comments (e.g., refrigerate immediately). Once the entire order is filled, the grocer's employee inputs the total number of packages for the order to provide the final packaged order barcode. The final packaged order barcode is printed onto a label affixed to the corresponding packages as defined by the Perishability Ranking within the barcode, and each and every package is affixed with a final packaged order barcode. The initial and final packaged barcodes may be printed in different colored letters or a different colored background for use in distinguishing packages containing items associated with a specific Perishability Ranking.

It is important to emphasize that the inventive order specific barcode is distinct and separate from the UPC barcodes and Point of Sale codes currently used by grocery stores to track sales, automate the checkout process, monitor inventory, etc. because the present inventive barcode serves a different purpose. The invention's unique order-specific barcode drives the food packaging process at the grocer's location according to the off-site shopper's selected items and in this way provides a method for ensuring that off-site orders will have been packaged according to a defined procedure to help ensure optimal freshness of the off-site order. Indeed, an off-site food ordering process can only truly replace an actual on-site grocery visit if the grocer can ensure that all food items ordered by the off-site shopper, no matter what their degree of perishability, will be fresh at the time of pick up and delivery.

The invention, through its unique barcode(s), comprising either a one-dimensional and/or two-dimensional barcode, benefits the participating grocery store by: 1) providing a system for ensuring that pre-ordered groceries are properly packaged and stored according to their Perishability Ranking; 2) providing a system for planning the filling of the grocery list according to store's own storage capacity for storage of perishable items that require freezing or storage at 2-8° C.; 3) providing a system for ensuring the accuracy and completeness of the filled order to avoid customer complaints; and 4) providing a system for the grocery store employee to quickly scan the packages associated with the order to ensure that all packages are provided to the shopper upon pick-up or delivery. It is again emphasized that the unique barcodes do not replace the ubiquitous UPC codes but instead serve to ensure that OSSE orders are accurately filled, stored properly, and that subsequently all packages for a particular order are delivered to the off-site shopper who either chooses to pick up the groceries at the OSSE grocer's physical location or have them delivered to a specified location.

The inventive, order-specific barcode is printable on an adhesive-containing label at the grocery store site wherein each label is attached to the corresponding package(s) filled by the grocer's employee according to off-site shopper's grocery list generated via the invention's interactive software system. Although the barcode information itself may be in black, a label's background may be a different color to help the grocer and shopper quickly identify the groceries that need freezing or refrigeration. For example, the label for packages containing frozen-food items (Perishability Ranking 4) may be red while the label for non-perishable goods (Perishability Ranking 1) may be green. Alternatively, the barcode information itself may be in a different color depending upon the Perishability Ranking.

The complete barcode affixed to a package associated with the order is read by a barcode scanner when the order is ready for pick up or transfer to a delivery vehicle. The barcode scanner may be portable or attached to a store computer. The inventive package barcode system ensures that all packages associated with any given order no matter where stored as the result of their Perishability Ranking are delivered to the OSSE off-site shopper either as the result of pick up or delivery.

In addition, upon inputting the order number through the OSSE Grocer Application when an OSSE shopper arrives at the store for pick up or the packages are to be transported to a delivery vehicle, the grocer's employee will be alerted as to the total number of packages in the order and the location of the packages within the bricks and mortar store. The OSSE off-site shopper, by inputting the order number through the OSSE Shopper Application, will also receive information as to the total number of packages in her order as a cross check. For those off-site shoppers who are using the OSSE as a smart phone application, the shopper may herself scan a package's complete barcode information attached to package labels for future reference in the event of a problem with the order following pickup or delivery.

If an order is to packed within the same day and within a narrow time frame, the grocer's employee may proceed directly to the printing of the final packaged barcode instead of first printing the initial barcode. The dual barcode procedure is applicable to those situations where the off-site ordered groceries will not necessarily be packed on the same day pursuant to the invention's packaging fulfillment system and therefore the total number of packages is unknown.

The invention does not eliminate the usage of UPC barcodes or Point of Sale barcodes already associated with food items in virtually every grocery store. In contrast to the prior art, OSSE system provide an order-specific inventive barcode that compliments and supplements the UPC barcodes. By way of example, the finalized grocery list is organized according to Perishability Rankings. This level of ranking provides the participating OSSE system grocery store with an organized grocery list wherein every OSSE grocery list is organized on the basis of Perishability Rankings. Such information may also be used, for example, by grocery store management in assisting the grocery store in making informed decisions as to the purchase of new or additional storage equipment.

In addition, the invention, through its interactive software, provides a verified grocery order fill list directly to the off-site shopper's communication device through the OSSE Shopper Application. This feature allows the off-site shopper to easily have access to a copy of his/her receipt listing all of the items to be picked up or delivered until the receipt is deleted from the off-site shopper's communication device and eliminates the need for the off-site shopper to retain hard copies of sales receipts, items that are often lost or misplaced.

The foregoing grocery shopping and order fulfillment system is provided and operated as the result of software applications developed specifically for OSSE Grocery Administration and the OSSE Shopper Administration applications. As shown below, the OSSE Grocer Administration software and certain aspects of the OSSE Grocery Administration software provide for software driven interaction between the shopper and the grocer whereas certain aspects of the OSSE Grocery Administration are only specific for and accessible by the designated grocery store users which includes the store manager. If a grocery chain becomes an OSSE participant, an OSSE administrator on behalf of the grocery chain, is also designated as the individual having access to the OSSE Grocery Administration application.

Regarding the OSSE Grocer Application, in the preferred embodiment of the invention, viewing screens made accessible by the OSSE Shopper application software comprise the following:
Login screen.
OSSE account activation screen.
Landing page with icons to select the registered store chain or independent store.
Screen providing welcoming message from selected store.
Order history screen for showing details and item lists for open and completed orders.
Category screen for browsing of inventory by top-level category, subcategory, classes, subclasses, and Tiers.
Shortcuts screen with direct links to user's preferred brands
Shortcuts screen with direct links to Tier options.
Preferences screen to select any available Red Alert options and Black Out options or deactivate saved Red Alert and Black Out options from the off-site shopper's prior shopping expeditions
Favorites screen with links to items that are ordered frequently or are preferred by the user.
Settings screen to switch mode of order completion notification.
Notifications screen about the status of order processing and pick up date reminders.
Shopping list screen providing auto-generated lists based on previous orders.
Screen providing the shopper with the option to generate her own automated shopping list which can be added en block to the shopping cart while shopping.
Payment log screen for showing initial payment made and any adjustments made to the payment by the grocer as the: 1) result of ordered items sold by weight wherein the initial payment is adjusted upwardly or downwardly to reflect the price of the packaged item; and/or 2) result of the unavailability of an ordered item.
Shopping cart screen for allowing the shopper to manage and view the items in the shopping basket.
Virtual assistant screen for providing the shopper with guided instructions for fully taking advantage of the shopping experience.
Screen for viewing and being able to store initial shopping list and final packed order list.
Screen providing links to a shopper manual explaining various features of the OSSE shopper application.
Screen providing a breakdown of the off-site shopper's payment according to the percentages of the payment associated with specified categories of food and household good items.

Regarding the OSSE Grocer Administration software, the viewing screens and underlying pages made available to the grocery store administration and/or manager through the OSSE Grocer Administration software in the preferred embodiment comprise the following:
Authentication screen for login and log out.
Summary dashboard with graphs and statistics about customers, orders, payments, and pick up/delivery information.
Shopper management screen for adding, inviting, activating, and deactivating a shopper.
Management catalog screen for controlling items made available to the shopper from the grocer's inventory of food items and household goods.
Category management screen for allowing the store to group store inventory into categories, sub-categories, classes, and subclasses (brands).
Management workflow screen defining employee roles and responsibilities in fulfilling the order and optimal sequence of packaging steps.
Management alert screen defining alerts for the store manager or delegate based on order processing discrepancies, expiration of perishable stock at the time of pickup or delivery, or suspect use-by or sell-by dates based on existing inventory.
Management-shopper interaction templates providing for customization of email and text notification related to order confirmation, status of order processing, status of order packaging, pickup reminders, transfer to delivery vehicle confirmation, and disposal of any order left at the store.
Screen for product attribute management providing the grocer with the option of grouping certain items according to Tier classification(s) (e.g., organic foods), Red Alerts (e.g., products containing more than 20 mg of sugar), and Black Out options (e.g., bakery goods) commensurate with shopper preferences.
Perishable and non-perishable food category management screen allowing the store to group the offered inventory items into perishable and non-perishable goods that are further classified into top level categories, sub-categories, classes, and subclasses or brands. For internal use wherein visibility can be restricted to only certain designated employees.
Order management screen providing browsing and classification of an order as an order with or without perishable items. Includes a graphical progress bar especially for use with orders including perishable items to show movement of the order through the steps of packing, storage, pickup or delivery, and disposal. Red flag alerts appear when a perishable stock is at risk of expiration.
Order perishability classification screen for ranking the ordered items according to their Perishability Ranking ranging from 1 to 4 or in order of increasing perishability.
Reports screen providing configurable reports and data exports for management use including CSV download and PDF export function. Data exports defined by specified date range for configurable reports including information on the store's total orders, products offered for purchase, Red Alert and Black Out usage, most ordered non-perishable items, most ordered perishable items, average number of packages per order, average number days between the order date and the pick-up or delivery date, and disposal issues.
Promotions screen for generating store specific coupon codes that are auto-generated according to rules related to expiration dates of perishable items. Discount codes are shopper specific and applied automatically in shopping cart screen when a shopper is eligible (e.g., when the shopper has spent a designated amount of money either across several orders or within one order)
Switch board screen provides a graphic interface to control visibility of categories or promotions to shoppers,
Store layout interface is used to set up the graphical aisles and departments through which the shopper can use a movable icon to make choices.
Packaging screen provides for customization of instructions for the ordered items associated with each Perishability Ranking and assignment of store employee user roles in facilitating the packaging function. Orders from an off-site shopper under this screen can be graphically viewed by the store manager and store administrator at any time. Includes pages for generating dual inventive in-process packaging barcodes and completed order barcodes to track the number and storage location of the packages.
Storage instructions screen allows customization of instructions for each Perishable Rank and assignment of store user roles per ranking and designation of the storage unit location for packaged items.
Order pickup screen allows for scanning of the inventive completed order barcode to generate pick up/delivery checklist confirming retrieval of all packages and assignment of store user roles per perishability ranking to this function. Orders from off-site shoppers designated as pick up orders can be reviewed at any time and graphically viewed by the store manager and store administer at any time.
Delivery screen allows for generating an automated schedule of order delivery according to driving distance to shopper's delivery address by a store employee or a third party. It includes a webpage only viewable by the store manager and store administrator and delivery person wherein the delivery person is required to verify delivery and delivery time as well as document failed deliveries.
The order disposal screen covers orders that off-site shoppers failed to pick up within the stipulated time set under agreed-terms at the time of placing the order. The system sends the off-site shopper a series of notifications after failure of the off-site shopper to pick up the order until order's associated expiration date has been reached and disposal is initiated. The software generates a disposal manifest showing the scheduled delivery to a food bank or equivalent non-profit organization of items which have not expired. The associated expiration date is determined by the earliest use-by or sell-date designated for items assigned to Perishability Ranking 3.

Regarding the foregoing screens list it should be understood that numerous underlying webpages are associated with any particular screen classification.

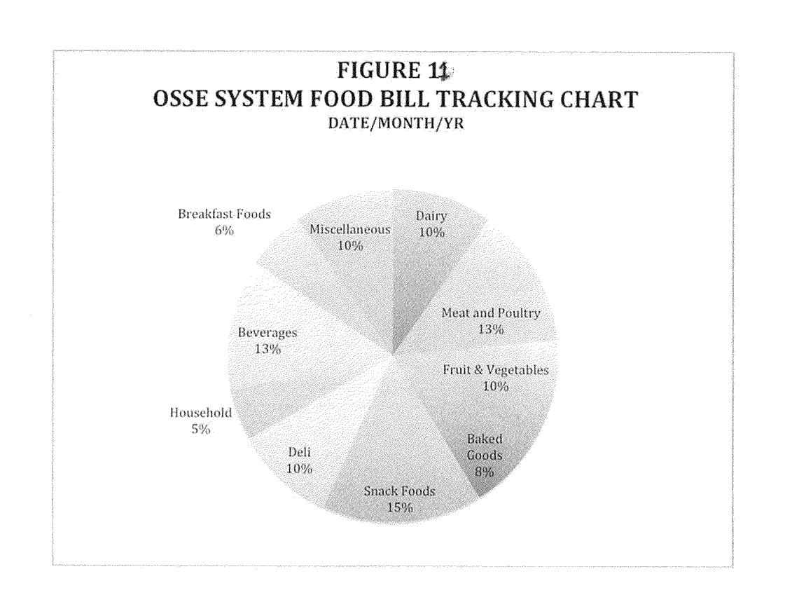

The foregoing description of the invention demonstrates how it transforms the off-site shopper into a truly knowledgeable consumer from a food selection perspective. Another embodiment of the invention provides the user with the option of also knowing exactly how his or her hard-earned money is being spent on grocery store purchases. Referring not to FIG. 11, one embodiment of the OSSE provides a graph for each shopping experience showing the percentage of the total amount of the bill spent on various top-level food classifications as selected by the off-site shopper. From within each classification, the invention includes a means for further tracking the percentage of the food bill pertaining to particular food preferences(s) or Tier options. As an example, for a grocery bill of $200.00, the OSSE Shopper Administrator software allows the shopper to track the percentage of the bill associated with, for example, organic foods (e.g., ten percent (10.0%)) and store brand foods (e.g. twenty percent (20.0%)). As a result, the user will have ready accessible information as to how shopping choices may be altered so as to either save money (e.g., picking more store brands), adjust food selections (e.g., substitute more healthful food choices for high caloric snack foods and desserts), and/or extend the buying power of the shopper's food budget (e.g., substituting high protein beans for certain meats). Again, the OSSE system transforms the grocery shopping experience into one wherein the off-site grocery shopping process can transformed from an ad hoc process, generally limited to non-perishable items, into one that is thoroughly knowledge driven. Such a transformative off-site shopping system is absent from the prior art.

Another embodiment of the invention provides a social network via its interactive software through which participating OSSE users can share recipes and interact with other off-site shoppers on the basis of their food preferences and/or health concerns. As an example, those OSSE off-site shoppers who are vegans may become members of, for example, the Vegan Social OSSE Group and post recipes, new vegan items, etc. and in this way join a community dedicated to promoting the healthy and tasty enjoyment of vegan food. Those OSSE off-site shoppers who wish to reduce their gluten intake may become members of, for example, the Gluten-Intolerance OSSE Group and thereby join a community dedicated to promoting healthy and tasty enjoyment of gluten-free foods. The social network also benefits the OSSE system participating grocery store because the store can inform social network members of new food products and sales specific for the social networking group, and thereby engage in targeted marketing according to a shopper's actual food preferences as indicated by their usage of provided Tier, Red Alert, and Black Out Options. Membership in these groups is limited to OSSE participating shoppers.

Finally, referring now FIG. 9A, an embodiment of the OSSE methodology provides for shopping options specific for a particular cuisine. Thus, if an OSSE shopper wishes to primarily stick with a Mediterranean diet, the OSSE's sorting methodology will list foods falling into this category. As discussed above, the off-site shopper can further sort the featured items as to organic only, store brand, low cholesterol, etc.

The illustrations of embodiments described herein are intended to provide a general understanding of the structure of various embodiments, and they are not intended to serve as a complete description of all of the elements and features of the systems that may make use of the structures described herein. Many other embodiments will be apparent to those of skilled in the art upon reviewing the above description. Although minor modifications to the teachings herein will occur to those well versed in the art, it shall be understood that what is intended to be included within the scope of the patent warranted hereon are all such embodiment to the art this invention hereby contributes to, and that the scope shall not restricted, except in light of the appended claims and their equivalents.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not interpreted as reflecting an intention that the claimed embodiments require more features than are expressly recited in each claim. Rather, as the following claims reflect, inventive subject matter lies in less than all features of a single enclosed embodiment. Thus the following claims are hereby incorporated into the Detailed Description, with each claim standing on its own as a separately claimed subject matter.

What is claimed is:

1. A method utilizing a computer system for providing for the timely and accurate fulfillment by said computer system's grocer retail users of grocery orders placed by the said computer system's customer users comprising the steps of:
(a) Providing access to the items from grocer retail user's inventory said retail user is making available for purchase to the communication device of an approved customer user who has been assigned customer identification number;
(b) Providing narrowing tier options and red alert options for directing said customer user to preferred items being offered through said retail user's inventory;
(c) Providing eliminating blackout options by said retailer user for eliminating the inclusion of grocery and household items in said inventory according to said customer user's selected said eliminating options;
(d) Receiving a first grocery order list comprising said customer user's selections for purchase from said inventory according to said customer's users selected said narrowing options and selected eliminating options, designation of the type of order retrieval, and selected retrieval date;
(e) Assigning an order number to said grocery list;
(f) Sorting the items in said first grocery order list according to an assigned perishability ranking number from least perishable to more perishable;
(g) Providing a packaging procedure comprising order fulfillment directives packing items grocery order list according to said perishability ranking;
(h) Providing total cost of said customer user's selections to said off-site shopper;
(i) Securely receiving advance payment from said communication device by credit card or debit card;
(j) Providing a plurality of status updates to said communication device to assist customer user in tracking the fulfillment of her purchase order;
(k) Providing a plurality of notifications to said communication device of any item from said first grocery list that cannot be made available according to said selected retrieval date;
(l) Providing an updated grocery order fill list to said communication device showing any changes in said first grocery list as to item availability or order cost;
(m) Providing an updated grocery order fill list showing the weight of actual packaged item wherein said actual packaged item is from a food category wherein the precise weight and resultant price of the selected item is determined upon actual selection;
(n) Securely crediting said credit card or debiting credit card or debit reflecting items specified in first grocery order list not appearing in said final sorted grocery order fill list;
(o) Securely crediting said credit card or debiting credit card or debit reflecting items specified in first grocery order requiring actual weighing before an actual price can be determined; and
(p) Providing a plurality of notifications to said communication device that said selections are ready for retrieval.

2. The said perishability ranking of claim 1 comprising a plurality of perishability rankings determinative of the storage conditions to be used by a retail user's employee to store items listed on said first grocery order list wherein said perishability ranking 1 is for items storable at room temperature, perishability ranking 2 is for items that may be refrigerated either at the grocery store or at the shopper's home; perishability ranking 3 is for items requiring refrigeration; and perishability ranking 4 is for items requiring freezing.

3. A method utilizing the computer system of claim 1 for determining optimal packaging and storage conditions of said ordered items in off-site shopper's placed order for ensuring optimal food freshness and order accuracy by said grocer comprising the steps of:
(a) Applying a perishability ranking to every item in said first grocery order list upon receipt of said first order grocery list from said communication device;
(b) Sorting said first grocery order list according to said perishability ranking in order of increasing perishability such that the most perishable items will be filled last;
(c) Providing a packaging order schedule for grocery employees for packing items from said first grocery list into packages according to said perishability ranking and said off-shopper's said retrieval date;
(e) Providing a first printable bar code comprising a series of numbers and letters including information on said perishability ranking; said order number; and said customer identification number;
(f) Transmitting said first printable bar code to a bar code scanning device in said grocery store;
(g) Receiving information from employees of said grocery store assigned to filling said order comprising the total number of said packages associated with said order number; package fill date for the associated package; total number of packages associated with any of said perishability rankings for optimal packaging; storage unit location and, optionally, notes or comments about said order;
(h) Generating updated second bar codes comprising a series of numbers and letters including all information on first printable barcode and the said information received from said employees assigned to filling said order;
(i) Transmitting said updated printable bar codes to said barcode scanning device;
(j) Transmitting barcode printing information to a printer device connected to said computer system either directly or through a network; and
(k) Receiving updated barcode information from said bar code scanning device for every said package associated with said order upon retrieval of said filled order to confirm entire order being made available upon retrieval; and
(l) Generating a final order list showing the total number of packages associated with said order and the number of packages stored at said specified storage unit storage location.

4. A method for carrying out the computer-generated packaging procedure of claim 3 by a store employee of said computer system retail user comprising the steps of:
(a) Selecting and packing items according to said packaging procedure and schedule;
(b) Scanning selected items' UPC or point-of-sale codes for any item where the actual price is determined by weight;
(c) Affixing said first printable bar codes of claim 2 printed onto said package labels to packages for items associated with the first bar code's designated perishability ranking as filling of any particular package based on said perishability ranking is commenced.
(d) Inputting into said computer system the information required for generating said second updated printable bar codes when all items associated with a designated said perishability ranking have been packaged;
(e) Affixing said second printable bar code printed onto said package labels to said corresponding package;
(f) Storing said packages according to associated said perishability ranking and said storage unit location specified on said second printable bar code;
(g) Retrieving said packages from their said storage units for transfer to said off-site shopper according to said retrieval selection; and
(h) Scanning said affixed updated bar codes of all packages associated with said order with said bar code scanning device.

5. The method of claim 1 wherein said communication device comprises one of a wireless mobile phone, desktop computer, and a laptop.

6. The method of claim 1 wherein said computer system communicates with said communication device over a network infrastructure.

7. The said printable first bar code and second updated printable bar codes of claim 2 wherein said barcodes are printed onto labels with adhesive for affixing said labels onto said filled packages.

8. The said printed labels of claim 7 wherein said labels vary in color according to said perishability ranking.

9. A means for retail users to make changes in the inventory they choose to make available for purchase to the customer user by the method of claim 1.

10. A means for said retail users to make available said red alerts or blackout options for selected items within said retail user's grocer's off-site shopping inventory.

11. A means for sorting food items and household goods items according to at least one defining characteristic as defined by said red alert, said blackout, or said narrowing tier options to be used for categorizing said food item.

12. A means for said retailer users to provide a plurality of notices to said customer user concerning the status of the order and any changes in the order.

13. A means for said retail user to adjust the price of said grocery order which reflects the actual weight and associated price of an ordered food item sold by weight.

14. A means for said customer users to browse said retail user's inventory using advanced search options for narrowing choices and speeding up the offsite shopping process.

15. A means for said customer user to activate said available red alerts or blackout options of claim 7.

16. A means for graphically tracking the progress of said order fulfillment from receipt of said order through pick-up or delivery of the order by said retail user.

17. A means for converting said sorted grocery list into the order fulfillment directives of claim 2.

18. A means for said customer user to graphically monitor spending habits and purchase history.

19. A means for customer users to interact with other offsite shoppers further allowing an offsite shopper to purchase items for another offsite shopper and notify the receiving offsite user of the purchase.

20. A means for customer users to search for products by designating specific retailer users within a certain geographical area by zip code and limit searches to particular products and prices.

21. A method for use in maximizing customer user savings using the communication device comprising the steps of:
(a) preparing a shopping list;
(b) selecting a plurality of retailer users that utilize the computer system of claim 1; and
(c) receiving price information from said selected retailer users to fill the order according to the customer user's said shopping list.

22. The computer system of claim 1 comprising one or more servers for running the invention's software means wherein the servers may be located within a specific retailer user location or at a co-located data center operated either by the grocery store or a third party; a manual mouse; a computer located at said retailer user's bricks and mortar store, a keyboard, mouse, and barcode scanner attached to said computer.

23. A refrigerator storage unit for storing items including a bar code scanner for scanning said printed updated bar codes of affixed to packages consisting of items associated with perishability ranking 3 upon placement into and removal from said refrigerator storage unit.

24. A freezer storage unit including a bar code scanner for scanning said printed updated bar codes of affixed to packages consisting of items associated with perishability rankings 4 upon placement into and removal from said freezer storage unit.

25. A combined refrigerator and freezer unit including a bar code scanner for scanning said printed updated bar codes of affixed to packages consisting of items associated with perishability rankings 3 and 4 upon placement into and removal from said combined refrigerator and freezer unit.
